(19) United States
(12) Patent Application Publication
(10) Pub. No.: US 2026/0188581 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Sang Hyuk LEE, Suwon-si (KR); Jong Hoon KIM, Suwon-si (KR)

(73) Assignee: SAMSUNG ELECTRO-MECHANICS CO., LTD., Suwon-si (KR)

(21) Appl. No.: 19/407,339

(22) Filed: Dec. 3, 2025

(30) Foreign Application Priority Data
Dec. 27, 2024 (KR) 10-2024-0198396

(51) Int. Cl. H01G 4/224; H01G 2/12; H01G 4/30

(52) U.S. Cl. CPC H01G 4/224; H01G 2/12; H01G 4/30

(57) ABSTRACT

A multilayer electronic component includes a body having first and second surfaces opposing each other in the first direction, third and fourth surfaces opposing each other in a second direction, fifth and sixth surfaces opposing each other in a third direction to form a hexahedral shape, and an external electrode disposed on the third and fourth surfaces. In at least one cross-section, among a cross-section in first and second directions of the body and a cross-section in first and third directions of the body, at least one of corner regions connecting two adjacent surfaces to each other, among the first to sixth surfaces, includes a first curved section connected to one surface, among the two adjacent surfaces, a second curved section connected to the other surface, among the two adjacent surfaces, and a straight section connecting the first and second curved sections to each other.

### CROSS-REFERENCE TO RELATED APPLICATION(S)

This application claims the benefit of priority to Korean Patent Application No. 10-2024-0198396 filed on Dec. 27, 2024 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

An MLCC may be used as a component of various electronic devices due to having a small size, ensuring high capacitance and being easily mounted. With the miniaturization and high-output power of various electronic devices such as computers and mobile devices, demand for miniaturization and implementation of high capacitance of multilayer ceramic capacitors has also been increasing.

A polishing process, one of various manufacturing processes of an MLCC, may be one of the more important operations, and may directly affect a surface condition and quality of an MLCC chip.

An MLCC polishing process may be a process of refining a surface and an edge of an MLCC chip after high-temperature sintering, exposing an internal electrode, and optimizing a physical shape of the chip. The MLCC polishing process is known to be an essential operation so as to ensure electrical characteristics and reliability of an MLCC.

In the MLCC polishing process, it may be important to form an appropriate level of roundness on the chip surface to ensure moisture resistance reliability, and to prevent chipping defects.

An MLCC polishing process according to the related art may be performed by introducing tens of thousands of chips and auxiliary materials into a sealed rotating structure to induce abrasion of the chips. However, such a process may have a technical issue in that it is difficult to monitor polishing behavior of the chips in real time in the sealed structure. In addition, in order to manage quality variation of the polishing process or to perform improvement evaluation, thousands of sampling measurements may be necessary, and analyzing cross-sections of the chips in each manufacturing batch may consume a large amount of time and resources.

In addition, in order to form an appropriate level of roundness on the chip surface through the MLCC polishing process according to the related art, sufficient polishing time may be required, and chipping defects may be likely to occur during the polishing process.

Accordingly, there is a need to develop a novel structure of a multilayer electronic component capable of preventing chipping defects and improving moisture resistance reliability. In addition, there is a need to develop a novel structure of a multilayer electronic component capable of overcoming the inefficiency of quality control and the limitation of real-time monitoring that occur in the MLCC polishing process according to the related art.

### PRIOR ART DOCUMENT

### Patent Document

(Patent Document 1) Korean Patent Application Publication No. 10-2015-0011263

### SUMMARY

An aspect of the present disclosure is to provide a multilayer electronic component having excellent reliability.

Another aspect of the present disclosure is to provide a multilayer electronic component in which chipping defects are suppressed.

Another aspect of the present disclosure is to provide a multilayer electronic component having improved moisture resistance reliability.

Another aspect of the present disclosure is to provide a method of manufacturing a multilayer electronic component in which chipping defects are suppressed.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and an internal electrode alternately disposed with the dielectric layer in a first direction, the body having first and second surfaces opposing each other in the first direction, third and fourth surfaces connected to the first and second surfaces, the third and fourth surfaces opposing each other in a second direction, fifth and sixth surfaces connected to the first to fourth surfaces, the fifth and sixth surfaces opposing each other in a third direction, and an external electrode disposed on the third and fourth surfaces. In at least one cross-section, among a cross-section in the first and second directions of the body and a cross-section in the first and third directions of the body, at least one of corner regions connecting two adjacent surfaces to each other, among the first to sixth surfaces, may include a first curved section connected to one surface, among the two adjacent surfaces, a second curved section connected to the other surface, among the two adjacent surfaces, and a straight section connecting the first and second curved sections to each other.

According to another aspect of the present disclosure, there is provided a method of manufacturing a multilayer electronic component, the method including forming a laminated bar by laminating a plurality of ceramic green sheets in a first direction, forming a groove in a second direction, perpendicular to the first direction, and in a third direction, perpendicular to the first and second directions, in an upper surface and a lower surface in the first direction of the laminated bar, obtaining a unit laminated bar by cutting the laminated bar along the groove, obtaining a body by sintering the unit laminated bar, and forming an external electrode on the body. The method may further include a polishing operation of polishing the unit laminated bar before sintering, or polishing the body before forming the external electrode.

According to example embodiments of the present disclosure, a multilayer electronic component may have improved reliability.

According to example embodiments of the present disclosure, in a multilayer electronic component, chipping defects may be suppressed.

According to example embodiments of the present disclosure, a multilayer electronic component may have improved moisture resistance reliability.

According to example embodiments of the present disclosure, in a method of manufacturing a multilayer electronic component, chipping defects may be suppressed.

However, the various advantages and effects of the present disclosure are not limited to those set forth herein, and will be more easily understood in the course of describing specific example embodiments of the present disclosure.

### BRIEF DESCRIPTION OF DRAWINGS

The above and other aspects, features, and advantages of the present disclosure will be more clearly understood from the detailed following description, taken in conjunction with the accompanying drawings, in which:

FIG. 1 is a schematic perspective view of multilayer electronic component according to an example embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is an enlarged view of region “K1” of FIG. 1;

FIG. 5 is a diagram corresponding to region “K1” of FIG. 1 of an example according to the related art;

FIG. 6 is a schematic perspective view of an operation of obtaining a laminated bar;

FIG. 7 is a schematic perspective view of a laminated bar before a groove is formed;

FIG. 8 is a front view of a laminated bar while a groove is being formed;

FIG. 9 is an enlarged view of region “K2” of FIG. 8;

FIG. 10 is a side view of a laminated bar having both surfaces in a first direction in which a groove is formed;

FIG. 11 is a front view of a laminated bar having both surfaces in a first direction in which a groove is formed; and

FIG. 12 is a perspective view of a laminated bar having both surfaces in a first direction in which a groove is formed.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means t that it may include other elements as well, rather than excluding other elements, unless specifically stated otherwise.

In the drawings, a first direction may be defined as a lamination direction or a thickness (T) direction, a second direction may be defined as a length (L) direction, and a third direction may be defined as a width (W) direction.

### Multilayer Electronic Component

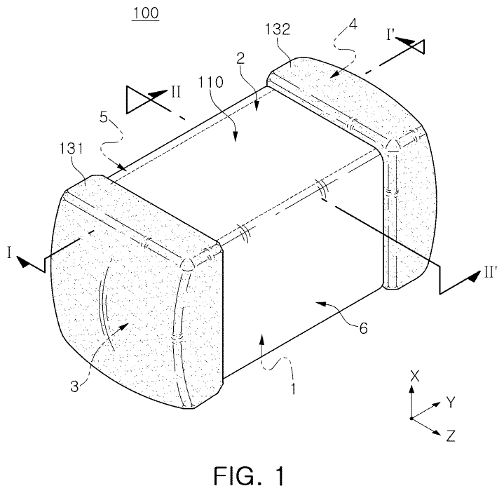

FIG. 1 is a schematic perspective view of a multilayer electronic component according to an example embodiment of the present disclosure.

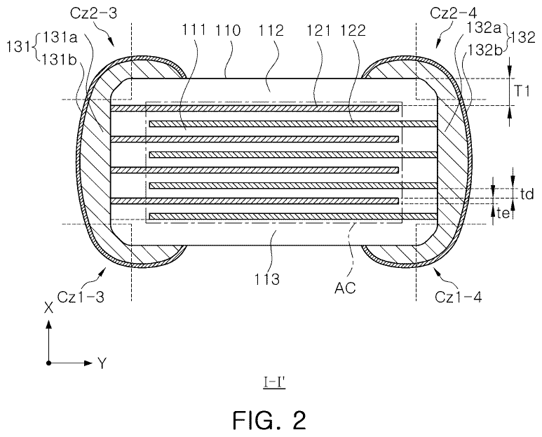

FIG. 2 is a schematic cross-sectional view taken along line I-I′ of FIG. 1.

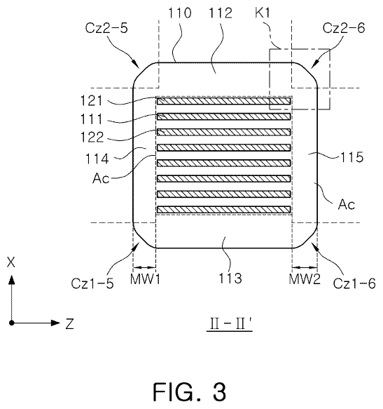

FIG. 3 is a schematic cross-sectional view taken along line II-II′ of FIG. 1.

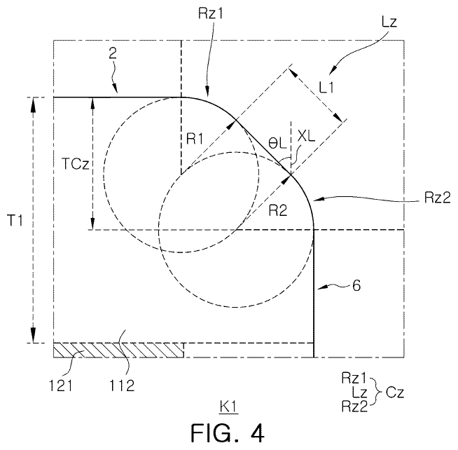

FIG. 4 is an enlarged view of region “K1” of FIG. 1.

Hereinafter, a multilayer electronic component 100 according to an example embodiment of the present disclosure will be described in detail with reference to FIGS. 1 to 4. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

A multilayer electronic component 100 according to an example embodiment of the present disclosure may include a body 110 including a dielectric layer 111 and internal electrodes 121 and 122 alternately laminated with the dielectric layer in a first direction, the body having a first surface 1 and a second surface 2 opposing each other in the first direction, a third surface 3 and a fourth surface 4 connected to the first and second surfaces, the third surface and the fourth surface opposing each other in a second direction, and a fifth surface 5 and a sixth surface 6 connected to the first to fourth surfaces, the fifth surface and the sixth surface opposing each other in a third direction, and external electrodes 131 and 132 disposed on the third and fourth surfaces. In at least one cross-section, among a cross-section in the first and second directions of the body and a cross-section in the first and third directions of the body, at least one of corner regions Cz connecting two adjacent surfaces to each other, among the first to sixth surfaces, may include a first curved section Rz1 connected to one surface, among the two adjacent surfaces, a second curved section Rz2 connected to the other surface, among the two adjacent surfaces, and a straight section Lz connecting the first and second curved sections to each other.

In other words, the at least one edge connecting two adjacent surfaces to each other includes a rounded portion having a first curved section connected to a first among the two adjacent surfaces, a second curved section connected to a second among the two adjacent surfaces, and a straight section connecting the first and second curved surfaces.

In the related art, a corner region may be polished into a round shape to prevent chipping defects and improve moisture resistance reliability. However, in order to form an appropriate level of roundness, sufficient polishing time may be required, and chipping defects may be likely to occur during the polishing process.

According to an example embodiment of the present disclosure, the corner region Cz, connecting two adjacent surfaces to each other, may include the first curved section Rz1 connected to one surface, among the two adjacent surfaces, the second curved section Rz2 connected to the other surface, among the two adjacent surfaces, and the straight section Lz connecting the first and second curved sections to each other, such that chipping defects may not only be prevented and moisture resistance reliability may be improved, but also polishing time may be reduced, thereby suppressing the occurrence of chipping defects during a polishing process and fundamentally preventing chipping defects.

Hereinafter, each of components included in the multilayer electronic component 100 according to an example embodiment of the present disclosure will be described.

In the body 110, the dielectric layer 111 and the internal electrodes 121 and 122 may be alternately laminated.

A specific shape of the body 110 is not limited. However, as illustrated, the body 110 may have a hexahedral shape or a shape similar thereto. During a sintering process, ceramic powder particles, included in the body 110, may shrink, such that the body 110 may not have a hexahedral shape having perfectly straight lines.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in the second direction, and fifth and sixth surfaces 5 and 6 connected to the third and fourth surfaces 3 and 4, the fifth and sixth surfaces 5 and 6 opposing each other in the third direction.

The body 110 may include a corner region Cz connecting two adjacent surfaces to each other in a cross-section in the first and second directions or in a cross-section in the first and third directions, among the first to sixth surfaces.

According to an example embodiment of the present disclosure, in at least one cross-section, among a cross-section in the first and second directions of the body and a cross-section in the first and third directions of the body, at least one of corner regions connecting two adjacent surfaces to each other, among the first to sixth surfaces, may include a first curved section Rz1 connected to one surface, among the two surfaces, a second curved section Rz2 connected to the other surface, among the two surfaces, and a straight section Lz connecting the first and second curved sections to each other, such that chipping defects may not only be prevented and moisture resistance reliability may be improved, but also polishing time may be reduced, thereby suppressing the occurrence of chipping defects during a polishing process and fundamentally preventing chipping defects.

In the cross-section in the first and third directions, the corner region Cz may include a first-fifth corner region Cz1-5 connecting the first and fifth surfaces to each other, a first-sixth corner region Cz1-6 connecting the first and sixth surfaces to each other, a second-fifth corner region Cz2-5 connecting the second and fifth surfaces to each other, and a second-sixth corner region Cz2-6 connecting the second and sixth surfaces to each other.

In the cross-section in the first and second directions, the corner region may include a first-third corner region Cz1-3 connecting the first and third surfaces to each other, a first-fourth corner region Cz1-4 connecting the first and fourth surfaces to each other, a second-third corner region Cz2-3 connecting the second and third surfaces to each other, and a second-fourth corner region Cz2-4 connecting the second and fourth surfaces to each other.

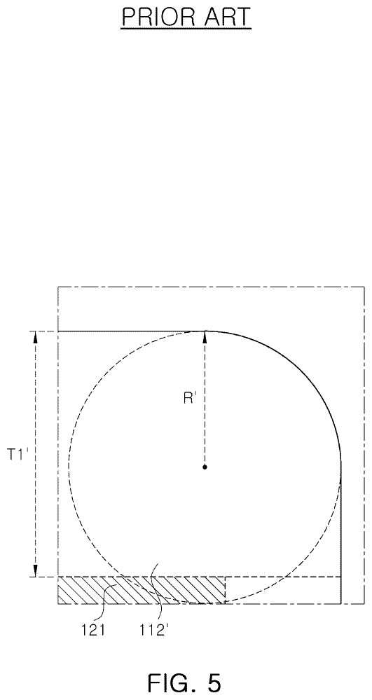

FIG. 5 is a diagram corresponding to region “K1” of FIG. 1 of an example according to the related art. Comparing FIG. 4 and FIG. 5 to each other, in the example according to the related art, in order to form an appropriate level of roundness, an edge may need to be polished to have a radius of curvature (R′) of about 0.6 times a thickness in a first direction (T1′) of a cover portion 112′. In this case, sufficient polishing time may be required, and chipping defects may be likely to occur during the polishing process.

Conversely, referring to FIG. 4, the corner region Cz of the present disclosure may include the first curved section Rz1 connected to the second surface, the second curved section Rz2 connected to the sixth surface, and the straight section Lz connecting the first and second curved sections to each other. Accordingly, it can be confirmed that a radius of curvature (R1) of the first curved section and a radius of curvature (R2) of the second curved section are significantly reduced as compared to the radius of curvature (R′) according to the related art. Accordingly, polishing time may be reduced as compared to the related art, thereby fundamentally reducing the possibility of chipping defects occurring.

In an example embodiment, an acute angle (θL), formed by the straight section Lz and the first direction (X-direction), may be greater than 30 degrees and less than 60 degrees. Referring to FIG. 4, the acute angle (θL), formed by the straight section Lz and a line XL indicating the first direction, may be greater than 30 degrees and less than 60 degrees.

Accordingly, the effect of suppressing chipping defects and the effect of improving moisture resistance reliability due to the corner region Cz may be further improved. When the angle (θL) is 30 degrees or less or 60 degrees or more, a radius of curvature of the first curved section or the second curved section may be excessively increased, and the effect of suppressing chipping defects and improving moisture resistance reliability due to the corner region Cz of the present disclosure may be insufficient.

Accordingly, an acute angle (θL), formed by the straight section Lz and the first direction, may be preferably greater than 30 degrees and less than 60 degrees, and more preferably, may be 40 degrees or more and 50 degrees or less.

In an example embodiment, when a radius of curvature of the first curved section is referred to as R1 and a radius of curvature of the second curved section is referred to as R2, R1/R2 may be 0.78 or more and 1.28 or less.

When a radius of curvature of the first curved section is referred to as R1 and a radius of curvature of the second curved section is referred to as R2, the effect of suppressing chipping defects and the effect of improving moisture resistance reliability of the present disclosure may be further improved as R1 and R2 have similar values. However, R1 and R2 may not need to be the same or similar to each other. For example, R1/R2 may be 0.78 or more and 1.28 or less. More preferably, R1/R2 may be 0.8 or more and 1.2 or less. More preferably, R1/R2 may be 0.9 or more and 1.1 or less.

In an example embodiment, the body 110 may include a capacitance formation portion Ac including the internal electrodes 121 and 122, a first cover portion 112 disposed on an upper portion in the first direction of the capacitance forming portion, and a second cover portion 113 disposed on a lower portion in the first direction of the capacitance forming portion, and the corner region may be disposed in the first and second cover portions 112 and 113.

In an example embodiment, when an average thickness in the first direction of the first cover portion is referred to as T1, and a length of a straight section in the corner region disposed in the first cover portion is referred to as L1, 0.207≤L1/T1 may be satisfied. Accordingly, the effect of suppressing chipping defects and the effect of improving moisture resistance reliability due to the corner region Cz may be further improved.

An upper limit of L1/T1 is not limited, However, when L1 is excessively large, it may be difficult to sufficiently secure a curved section. Accordingly, L1/T1≤1.248 may be satisfied. Accordingly, in an example embodiment, T1 and L1 may satisfy 0.207≤L1/T1≤1.248.

In an example embodiment, when an average thickness in the first direction of the first cover portion is referred to as T1, and radii of curvature of first and second rounded sections of the corner region disposed in the first cover portion are referred to as R1 and R2, respectively, R1/T1 and R2/T1 may be 0.2 or more. Accordingly, the effect of suppressing chipping defects and the effect of improving moisture resistance reliability due to the corner region Cz may be further improved.

In addition, upper limits of R1/T1 and R2/T1 are not limited, for example, R1/T1 and R2/T1 may be less than 0.6.

In an example embodiment, when an average thickness in the first direction of the first cover portion is referred to as T1, and a thickness in the first direction of the corner region Cz is referred to as TCz, TCz/T1≤0.75 may be satisfied.

A method of measuring L1, R1, R2, θL, T1, and TCz is not limited. For example, the body 110 may be polished up to a center in the second direction of the body 110 to expose a cross-section in the first and third directions of the body 110, or the body 110 may be polished up to a center in the third direction of the body 110 to expose a cross-section in the first and second directions of the body 110, and then L1, R1, R2, θL, T1, and TCz may be measured using an optical microscope, a scanning electron microscope (SEM), or the like.

The first to sixth surfaces of the body 110 may be generally flat surfaces, and a region from an end of each surface to an end of an adjacent surface may be considered as the corner region Cz.

Referring to FIG. 4, the end of each surface may refer to a point at which a flat surface ends or a point at which a curvature rapidly increases and a curved section begins. In addition, the first to sixth surfaces and the straight section may refer to regions having a significantly large radius of curvature or a radius of curvature close to infinity.

Referring to a change in radius of curvature according to an outline of the body from left to right in FIG. 4, the radius of curvature may be close to infinity up to a point at which the second surface 2 ends, but may rapidly decrease to R1 at a point at which the first curved section Rz1 begins. Thereafter, the radius of curvature may rapidly increase to a value close infinity at a point at which the straight section Lz begins. Thereafter, the radius of curvature may be close to infinity up to a point at which the straight section Lz, and then may rapidly decrease to R2 at a point at which the second curved section Rz2 begins. Thereafter, the radius of curvature may rapidly increase to a value close to infinity at a point at which the sixth surface 6 begins.

An image of a region corresponding to FIG. 4 may be obtained by scanning the region using an SEM. An outline of the body may then be extracted from the obtained image using an image analysis program. Subsequently, a radius of curvature may be measured by analyzing the extracted outline using CAD software. Through such analysis, a corner region, a straight section in the corner region, and first and second curved sections may be distinguished from each other.

The radius of curvature of the straight section Lz and the first to sixth surfaces of the body are not limited. However, the straight section Lz and the first to sixth surfaces of the body may have, for example, a radius of curvature that is 100 times or more than that of the first and second curved sections.

A plurality of dielectric layers 111, included in the body 110, may be in a sintered state, and adjacent dielectric layers 111 may be integrated with each other such that boundaries therebetween are not readily apparent without using an SEM. The number of laminated dielectric layers is not limited, and may be determined in consideration of a size of the multilayer electronic component. For example, the body may be formed by laminating 400 or more dielectric layers.

The dielectric layer 111 may be formed by preparing a ceramic slurry including ceramic powder particles, an organic solvent, and a binder, coating the slurry on a carrier film and drying the same to prepare a ceramic green sheet, and then sintering the ceramic green sheet. The ceramic powder particles are not limited as long as sufficient capacitance is obtainable therewith, and may be, for example, barium titanate-based (BaTiO₃)-based powder particles and CaZrO₃-based paraelectric powder particles. As a more specific example, the barium titanate-based (BaTiO₃)-based powder particles may be at least one of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and CaZrO₃-based paraelectric powder particles may be (Ca₁₋ₓSrₓ)(Zr_{1-y}Ti_{y})O₃ (0<x<1, 0<y<1).

Accordingly, the dielectric layer 111 may include at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and (Ca₁₋ₓSrₓ)(Zr_{1-y}Ti_{y})O₃ (0<x<1, 0<y<1).

The body 110 may include a capacitance formation portion Ac disposed in the body 110, the capacitance formation portion Ac having capacitance by including the first internal electrode 121 and the second internal electrode 122 disposed to oppose each other with the dielectric layer 111 interposed therebetween, and cover portions 112 and 113 disposed on upper and lower portions in the first direction of the capacitance formation portion Ac.

In addition, the capacitance formation portion Ac may be a portion contributing to forming capacitance of a capacitor, and may be formed by repeatedly laminating a plurality of first and second internal electrodes 121 and 122 on each other with the dielectric layer 111 interposed therebetween.

The cover portions 112 and 113 may be disposed on both surfaces in the first direction of the capacity formation portion Ac.

The cover portions 112 and 113 may include a first cover portion 112 disposed on the upper portion in the first direction of the capacitance formation portion Ac, and a second cover portion 113 disposed on the lower portion in the first direction of the capacitance formation portion Ac. The first cover portion 112 may be referred to as an upper cover portion, and the second cover portion 113 may be referred to as a lower cover portion.

The first cover portion 112 and the second cover portion 113 may be respectively formed by laminating one dielectric layer or two or more dielectric layers on upper and lower surfaces of the capacitance formation portion Ac in a thickness direction, and may basically serve to prevent the internal electrode from being damaged due to physical or chemical stress.

The first cover portion 112 and the second cover portion 113 may not include the internal electrode, and may include a material the same as that of the dielectric layer 111.

That is, the first cover portion 112 and the second cover portion 113 may include a ceramic material, and may include, for example, a barium titanate (BaTiO₃)-based ceramic material.

A thickness of each of the cover portions 112 and 113 is not limited. However, in order to easily achieve miniaturization and high capacitance of the multilayer electronic component, each of a thickness of the first cover portion 112 and a thickness of the second cover portion 113 may be 20 μm or less.

The thickness of the first cover portion 112 and the thickness of the second cover portion 113 may be equal to each other, but the present disclosure is not limited thereto, and the thickness of the first cover portion 112 and the thickness of the second cover portion 113 may have different values.

The thickness of the first cover portion 112 may refer to a size in the first direction, and an average value of sizes in the first direction of the first cover portion 112, measured at five points spaced apart from each other at equal intervals in the third direction, may be referred to as an average value (T1) of the first cover portion 112. An average thickness of the second cover portion 113 may be measured in the same manner.

The margin portions 114 and 115 may be disposed on the fifth and sixth surfaces of the body 110.

The margin portions 114 and 115 may include a first margin portion 114 disposed on the fifth surface and a second margin portion 115 disposed on the sixth surface. That is, the margin portions 114 and 115 may be disposed on both surfaces of the ceramic body 110 opposing each other in a width direction.

As illustrated in FIG. 3, the margin portions 114 and 115 may refer to regions between both ends of each of the first and second internal electrodes 121 and 122 and an interface of the body 110 in a cross-section of the body 110 cut in a width-thickness (W-T) direction.

The margin portions 114 and 115 may basically serve to prevent the internal electrode from being damaged due to physical or chemical stress.

The margin portions 114 and 115 may be formed by forming the internal electrode by coating a conductive paste on a ceramic green sheet, except for a portion of the ceramic green sheet on which a margin portion is to be formed.

In addition, in order to suppress a step portion caused by the internal electrodes 121 and 122, the internal electrodes may be laminated and then cut to be exposed to the fifth and sixth surfaces 5 and 6 of the body. Thereafter, one dielectric layer or two or more dielectric layers may be laminated on both side surfaces of the capacitance formation portion Ac in the third direction (width direction) to form the margin portions 114 and 115.

A width of each of the margin portions 114 and 115 is not limited. However, in order to easily achieve miniaturization and high capacitance of the multilayer electronic component, an average width of each of the margin portions 114 and 115 may be 20 μm or less.

The average width of each of the margin portions 114 and 115 may be an average size in the third direction (MW1) of a region in which the internal electrode is spaced apart from the fifth surface or an average size in the third direction (MW2) of a region in which the internal electrode is spaced apart from the sixth surface, and may have an average value of sizes in the third direction of each of the margin portions 114 and 115, measured at five points spaced apart from each other at equal intervals of a side surface of the capacitance formation portion Ac.

Accordingly, in an example embodiment, each of the average sizes in the third direction (MW1 and MW2) of regions in which the internal electrodes 121 and 122 are spaced apart from the fifth and sixth surfaces may be 20 μm or less.

The internal electrodes 121 and 122 may include first and second internal electrodes 121 and 122. The first and second internal electrodes 121 and 122 may be alternately disposed to oppose each other with the dielectric layer 111, included in the body 110, interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. The first external electrode 131 may be disposed on the third surface 3 of the body and connected to the first internal electrode 121, and the second external electrode 132 may be disposed on the fourth surface 4 of the body and connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance.

In an example embodiment, the internal electrodes 121 and 122 may include a first internal electrode 121 led out to the third, fifth, and sixth surfaces, and a second internal electrode 122 led out to the fourth, fifth, and sixth surfaces. Both ends in the third direction of each of first and second internal electrodes 121 and 122 may be in contact with the margin portions 114 and 115.

A conductive metal, included in the internal electrodes 121 and 122, may include at least one of Ni, Cu, Pd, Ag, Au, Pt, In, Sn, Al, Ti, and alloys thereof, but the present disclosure is not limited thereto.

An average thickness (td) of the dielectric layer 111 is not limited, but may be, for example, 0.1 μm to 10 μm. An average thickness (the) of each of the internal electrodes 121 and 122 is not limited, but may be, for example, 0.05 μm to 3.0 μm. In addition, the average thickness (td) of the dielectric layer 111 and the average thickness (the) of each of the internal electrodes 121 and 122 may be arbitrarily set depending on desired characteristics or usage. For example, in order to achieve miniaturization and high capacitance, in the case of a small IT electronic component, the average thickness (td) of the dielectric layer 111 may be 0.45 μm or less, and the average thickness (the) of each of the internal electrodes 121 and 122 may be 0.45 μm or less.

The average thickness (td) of the dielectric layer 111 and the average thickness (the) of each of the internal electrodes 121 and 122 may respectively refer to a size in the first direction of the dielectric layer 111, and a size in the first direction of each of the internal electrodes 121 and 122. The average thickness (td) of the dielectric layer 111 and the average size (the) of each of the internal electrodes 121 and 122 may be measured, for example, by scanning, with an SEM, a cross-section in the first and second directions of the body 110 at a magnification of 10,000. More specifically, the average thickness (td) of the dielectric layer 111 may be measured by measuring thicknesses of one dielectric layer 111 at multiple points of the dielectric layer 111, for example, thirty points spaced apart from each other at equal intervals in the second direction, and calculating an average value of the thicknesses. In addition, the average thickness (the) of each of the internal electrodes 121 and 122 may be measured by measuring thicknesses of each of the internal electrodes 121 and 122 at multiple points, for example, thirty points spaced apart from each other at equal intervals in the second direction, and calculating an average value of the thicknesses. The thirty points, spaced apart from each other at equal intervals, may be designated in the capacitance formation portion Ac. In addition, when such average value measurement is performed on ten dielectric layers 111 and ten internal electrodes 121 and 122, the average thickness (td) of the dielectric layer 111 and the average thickness (the) of each of the internal electrodes 121 and 122 may be further generalized.

The external electrodes 131 and 132 may be disposed on the third and fourth surfaces 3 and 4 of the body 110, respectively.

The external electrodes 131 and 132 may be disposed on the third and fourth surfaces 3 and 4 of the body 110, respectively, and may include first and second external electrodes 131 and 132 respectively connected to the first and second internal electrodes 121 and 122.

Referring to FIG. 1, the external electrodes 131 and 132 may be disposed to cover both end surfaces in the second direction of the margin portions 114 and 115.

In the present example embodiment, a structure in which the multilayer electronic component 100 has two external electrodes 131 and 132 is described, but the number and shape of the external electrodes 131 and 132 may be changed depending on the form of the internal electrodes 121 and 122 or other purposes.

Each of the external electrodes 131 and 132 may be formed of any material having electrical conductivity, such as a metal or the like, and a specific material may be determined in consideration of electrical characteristics, structural stability, or the like. In addition, each of the external electrodes 131 and 132 may have a multilayer structure.

For example, the external electrodes 131 and 132 may include electrode layers 131a and 132a disposed on the body 110, and plating layers 131b and 132b formed on the electrode layers.

As a more specific example of the electrode layers 131a and 132a, the electrode layers may be a sintered electrode including a conductive metal and glass, or a resin-based electrode including a conductive metal and resin.

In addition, the electrode layers 131a and 132a may have a form in which a sintered electrode and a resin-based electrode are sequentially formed on the body 110. In addition, the electrode layers 131a and 132a may be formed by transferring a sheet including a conductive metal onto the body 110 or by transferring a sheet including a conductive metal onto the sintered electrode.

A material having excellent electrical conductivity may be used as the conductive metal included in the electrode layers 131a and 132a, but the material is not limited. For example, the conductive metal may be at least one of nickel (Ni), copper (Cu), and an alloy thereof.

The plating layers 131b and 132b may serve to improve mounting characteristics. A type of each of the plating layers 131b and 132b is not limited, and each of the plating layers 131b and 132b may be a plating layer including at least one of Ni, Sn, Pd, and alloys thereof, and may be formed of a plurality of layers.

As a more specific example of the plating layers 131b and 132b, each of the plating layers 131b and 132b may be a Ni plating layer or a Sn plating layer, may have a form in which a Ni plating layer and a Sn plating layer are sequentially formed on the electrode layers 131a and 132a, and may have a form in which a Sn plating layer, a Ni plating layer, and a Sn plating layer are sequentially formed. In addition, each of the plating layers 131b and 132b may include a plurality of Ni plating layers and/or a plurality of Sn plating layers.

A size of the multilayer electronic component 100 is not limited.

For example, the multilayer electronic component 100 may have a size of 0603 (length: 0.6 mm, width: 0.3 mm) or more. In consideration of a manufacturing error or the like, a maximum length in the second direction (L) of the body 110 may be 0.69 mm or less, and a maximum width in the third direction (W) of the body 110 may be 0.39 mm or less.

Here, the maximum length in the second direction (L) of the body 110 may refer to a maximum size in the second direction of the body 110, the maximum width in the third direction (W) of the body 110 may refer to a maximum size in the third direction of the body 110, and a maximum thickness in the first direction (T) of the body 110 may refer to a maximum size in the first direction of the body 110.

However, it is not necessary to limit the size of the multilayer electronic component 100 to a small size. As the size of the multilayer electronic component 100 increases, the present disclosure may have a more apparent effect and structural difference. Accordingly, the multilayer electronic component 100 may have a size of 1005 (length: 1.0 mm, width: 0.5 mm) or more. In consideration of a manufacturing error or the like, the maximum length in the second direction (L) of the body 110 may be 1.1 mm or more, and the maximum width in the third direction (W) of the body 110 may be 0.55 mm or more.

### Method of Manufacturing Multilayer Electronic Component

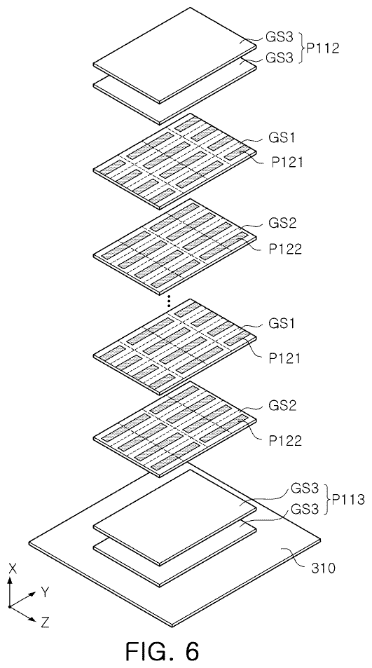

FIG. 6 is a schematic perspective view of an operation of obtaining a laminated bar.

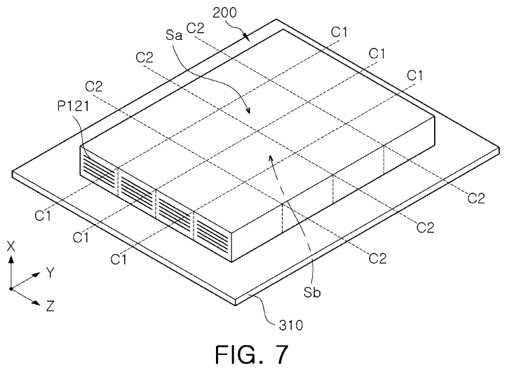

FIG. 7 is a schematic perspective view of a laminated bar before a groove is formed.

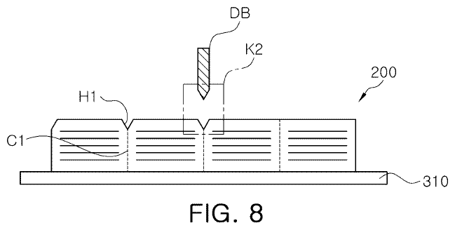

FIG. 8 is a front view of a laminated bar while a groove is being formed.

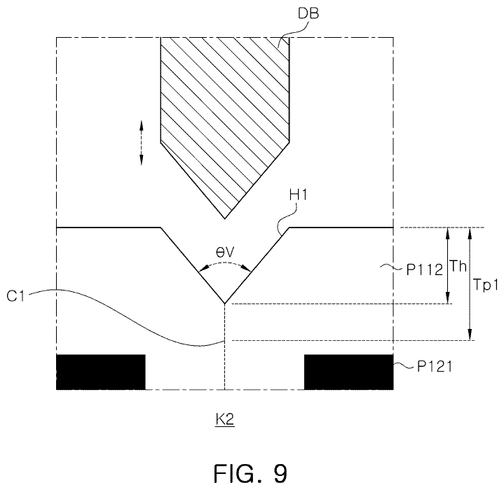

FIG. 9 is an enlarged view of region “K2” of FIG. 8.

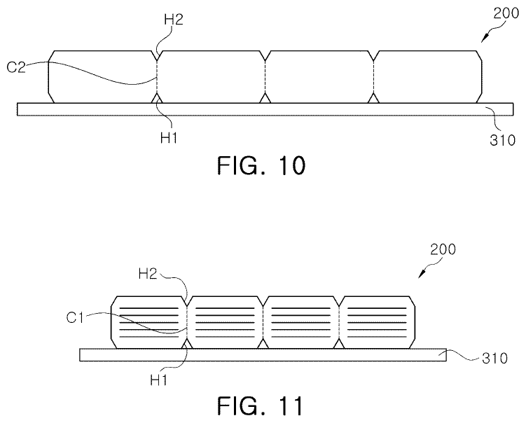

FIG. 10 is a side view of a laminated bar having both surfaces in a first direction in which a groove is formed.

FIG. 11 is a front view of a laminated bar having both surfaces in a first direction in which a groove is formed.

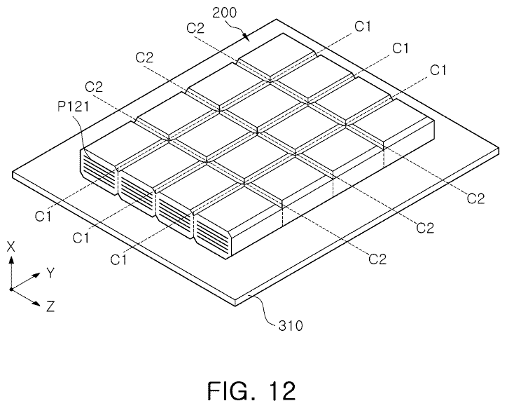

FIG. 12 is a perspective view of a laminated bar having both surfaces in a first direction in which a groove is formed.

Hereinafter, a method of manufacturing a multilayer electronic component will be described in detail with reference to FIGS. 6 to 12. The method of manufacturing a multilayer electronic component described below is an example of manufacturing the above-described multilayer electronic component 100, and it may not be necessary to manufacture the multilayer electronic component 100 only by the manufacturing method described below.

A method of manufacturing a multilayer electronic component according to an example embodiment of the present disclosure, the method may include forming a laminated bar 200 by laminating a plurality of ceramic green sheets p111 in a first direction, forming grooves H1 and H2 in a second direction, perpendicular to the first direction, and in a third direction, perpendicular to the first and second directions, in an upper surface in the first direction Sa and a lower surface in the first direction Sb of the laminated bar, obtaining a unit laminated bar by cutting the laminated bar along the grooves H1 and H2, obtaining a body 110 by sintering the unit laminated bar, and forming external electrodes 131 and 132 on the body. The method may further include a polishing operation of polishing the unit laminated bar before sintering, or polishing the body before forming the external electrode.

According to an example embodiment of the present disclosure, the grooves H1 and H2 may be formed in the laminated bar 200, and the unit laminated bar may be obtained by cutting the laminated bar 200 along the grooves H1 and H2, thereby not only suppressing chipping defects even with a reduced polishing process, but also improving moisture resistance reliability of the multilayer electronic component.

Hereinafter, each of operations of the multilayer electronic component according to an example embodiment of the present disclosure will be described in detail.

### Laminated Bar Formation

First, a laminated bar 200 may be formed by laminating a plurality of ceramic green sheets GS1, GS2, and GS3 in the first direction. At least a portion of the laminated bar 200 may be a portion included in a body 110 of the present disclosure after sintering.

In this case, the ceramic green sheets GS1, GS2, and GS3 may include a first ceramic green sheet GS1 on which a first internal electrode pattern p121 is printed, a second ceramic green sheet GS2 on which a second internal electrode pattern p122 is printed, and a third ceramic green sheet GS3 on which the first and second internal electrode patterns are not printed. The third ceramic green sheet GS3 may be laminated on an upper portion in the first direction p112 and a lower portion in the first direction p113 of the laminated bar 200, and the first and second ceramic green sheets GS1 and GS2 may be alternately laminated on a central portion in the first direction of the laminated bar 200.

In the operation of forming laminated bar 200, the plurality of ceramic green sheets GS1, GS2, and GS3 may first be laminated on a support film 310.

The support film 310 may serve to support the laminated bar 200 in which the plurality of ceramic green sheets GS1, GS2, and GS3 are laminated. In this case, the support film 310 may include an adhesive material such as latex, starch, cellulose, protein, isoprene rubber (IR), nitrile butadiene rubber (NBR), styrene butadiene rubber (SBR), chloroprene rubber (CR), silicon rubber, silicon-based, urethane-based, acryl-based, and mixtures thereof.

The plurality of ceramic green sheets GS1, GS2, and GS3 may be formed of a ceramic paste including ceramic powder particles, an organic solvent, a dispersing agent, and a binder. The ceramic powder particles may include a barium titanate-based material, a lead composite perovskite-based material, or a strontium titanate-based material as a raw material included in a dielectric layer 111 of the multilayer electronic component 100. The barium titanate-based material may include BaTiO₃-based ceramic powder particles. Examples of the ceramic powder may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) obtained by partially dissolving Ca or Zr in BaTiO₃. When the plurality of ceramic green sheets GS1 and GS2 are sintered, the sintered ceramic green sheets GS1 and GS2 may become the dielectric layer 111 included in the body 110. When the third ceramic green sheet GS3 is sintered, first and second cover portions 112 and 113 may be formed. The third ceramic green sheet GS3 may be formed of a material and an element as those of the first and second ceramic green sheets GS1 and GS2, but the present disclosure is not limited thereto.

The internal electrode patterns p121 and p122 may be formed on the ceramic green sheets GS1 and GS2 using an internal electrode paste including a conductive metal. The conductive metal included in the internal electrode patterns p121 and p122 is not limited, and a material having excellent electrical conductivity may be used. For example, the conductive metal may include at least one of nickel (Ni), copper (Cu), palladium (Pd), silver (Ag), gold (Au), platinum (Pt), tin (Sn), tungsten (W), titanium (Ti), and alloys thereof. A method of forming the internal electrode patterns p121 and p122 on the ceramic green sheets GS1 and GS2 is not limited. For example, the internal electrode patterns p121 and p122 may be formed by printing the internal electrode conductive paste including the conductive metal on the ceramic green sheets GS1 and GS2 using a screen-printing method or gravure printing method.

The internal electrode patterns p121 and p122 may include a first internal electrode pattern p121 formed on the ceramic green sheet GS1 and a second internal electrode pattern p122 formed on the other ceramic green sheet GS2.

### Groove Formation Operation

Subsequently, grooves H1 and H2 may be formed in a second direction (Y-direction), perpendicular to the first direction (X-direction), and in a third direction (Z-direction), perpendicular to the first and second directions, in an upper surface in the first direction Sa and a lower surface in the first direction Sb of the laminated bar 200. Accordingly, after a polishing process, a corner region Cz may include a straight section Lz, thereby suppressing hipping defects and improving moisture resistance reliability.

Referring to FIG. 7, the grooves H1 and H2 may be formed in the laminated bar 200 along groove formation lines C1-C1 and C2-C2. The groove formation lines C1-C1 and C2-C2 may include a line C1-C1, parallel to the second direction, and a line C2-C2, parallel to the third direction. The line C1-C1 may be disposed at substantially equal intervals in the third direction, and the line C2-C2 may be disposed at substantially equal intervals in the second direction.

FIG. 5 is a diagram corresponding to region “K1” of FIG. 4 of an example according to the related art. In the example according to the related art, a polishing process may be performed after cutting a laminated bar along C1-C1 and C2-C2 without forming a groove in the laminated bar. Accordingly, roundness may be formed by the polishing process, as illustrated in FIG. 5. in order to form an appropriate level of roundness, an edge may need to be polished to have a radius of curvature (R′) of about 0.6 times a thickness in a first direction (T1′) of a cover portion 112′. In this case, sufficient polishing time may be required, and chipping defects may be likely to occur during the polishing process.

Conversely, in the present disclosure, after forming grooves H1 and H2 in a laminated bar 200, the laminated bar may be cut along C1-C1 and C2-C2, and then a polishing process may be performed. Accordingly, a portion of grooves H1 and H2 may remain as a straight section Lz due to the polishing process, and both ends of the straight section Lz may have curved sections Rz1 and Rz2 formed due to polishing. Referring to FIG. 4, a corner region Cz of the present disclosure may include a first curved section Rz1 connected to the second surface, a second curved section Rz2 connected to the sixth surface, and a straight section Lz connecting the first and second curved sections to each other. Accordingly, it can be confirmed that a radius of curvature (R1) of the first curved section and a radius of curvature (R2) of the second curved section are significantly reduced as compared to the radius of curvature (R′) according to the related art. Accordingly, polishing time may be reduced as compared to the related art, thereby fundamentally reducing the possibility of chipping defects occurring and improving moisture resistance reliability.

A method of forming the grooves H1 and H2 in the laminated bar 200 is not limited. For example, the grooves H1 and H2 may be formed using a blade DB.

In an example embodiment, a thickness in the first direction (Th) of each of the grooves H1 and H2 formed in the upper surface in the first direction Sa of the laminated bar 200 may be 50% or less of a thickness in the first direction (Tp1) of the upper portion in the first direction p112. Similarly, a thickness in the first direction of each of the grooves H1 and H2 formed in the lower surface in the first direction Sb of the laminated bar 200 may be 50% or less of a thickness in the first direction of the lower portion in the first direction p113.

In an example embodiment, the grooves H1 and H2 may be disposed in a region not overlapping at least one of the first internal electrode pattern p121 and the second internal electrode pattern p122 in the first direction. Among the groove formation lines C1-C1 and C2-C2, C1-C1 may not overlap the first internal electrode pattern p121 and the second internal electrode pattern p122 in the first direction, and a portion of C2-C2 may be set to overlap the first internal electrode pattern p121 or the second internal electrode pattern p122 in the first direction.

In an example embodiment, the grooves H1 and H2 may have a V-shape. Specifically, referring to FIG. 11, the groove formed in the second direction may have a V-shape in a cross-section of the body in the first and third directions. Referring to FIG. 10, the groove formed in the third direction may have a V-shape in a cross-section of the body in the first and second directions. As the grooves H1 and H2 have a V-shape, the corner region Cz may be easily formed to include the straight section Lz after polishing.

The grooves H1 and H2 having a V-shape may be formed by forming a groove using the blade DB having a V-shape.

In an example embodiment, an angle (θV), formed by two sides of the V-shape, may be greater than 60 degrees and less than 120 degrees. Accordingly, an acute angle (θL), formed by the straight section Lz and the first direction (X-direction), may be controlled to be greater than 30 degrees and less than 60 degrees, thereby further improving the effect of suppressing chipping defects and the effect of improving moisture resistance reliability due to the corner region Cz.

More preferably, the angle (θV), formed by the two sides of the V-shape, may be 80 degrees or more and 100 degrees or less.

### Cutting Operation

A unit laminated bar may be obtained by cutting the laminated bar 200 along the grooves H1 and H2.

Referring to FIG. 12, the laminated bar 200 may be cut along C1-C1 and C2-C2, perpendicular to each other.

The means for cutting the laminated bar 200 is not limited. For example, the laminated bar 200 may be cut using a blade cutting method, a guillotine cutting method, or a laser cutting method.

In an example embodiment, the cutting may be performed along a point at which the two sides of the V-shape meet. That is, the cutting may be performed along a vertex of the V-shape.

### Polishing Operation

Subsequently, a polishing process of polishing the unit laminated bar may be performed. Alternatively, after sintering the unit laminated bar to obtain a body, a polishing process of polishing the body may be performed before forming an external electrode.

The polishing process may be performed by introducing tens of thousands of unit laminated bars or bodies (hereinafter, referred to as “chips”) and auxiliary materials into a sealed rotating structure to cause abrasion of the chips. The auxiliary materials may include an abrasive, a lubricant, or the like, and the abrasive may include ceramic particles, a polishing bead, or the like.

Tens of thousands of chips may be processed in a sealed state during the polishing process, such that it may be difficult to monitor a polishing condition of an individual chip in real time. In addition, for variation management and improvement evaluation, thousands of sample chips may need to be analyzed, which may consume a large amount of time and resources.

According to an example embodiment of the present disclosure, the polishing process may be performed after grooves H1 and H2 are formed in the laminated bar 200, such that polishing time may be reduced, thereby fundamentally reducing the possibility of chipping defects occurring and improving moisture resistance reliability.

### Sintering Operation

The unit laminated bar may be sintered to obtain the body 110. The sintering temperature is not limited. However, for example, sintering may be performed at 1000° C. to 1300° C. In addition, sintering may be performed under a reducing atmosphere.

When the polishing process is not performed before sintering, a process of polishing the body may be performed before forming an external electrode.

### Operation of Forming External Electrode

Subsequently, an external electrode may be formed on the body. The multilayer electronic component 100 may be manufactured by forming external electrodes 131 and 132 on one surface and the other surface in the second direction of the body 110, respectively.

For example, when base electrode layers 131a and 132a include a sintered electrode layer, the body 110 may be dipped into an external electrode conductive paste including metal powder particles, glass frit, a binder, and an organic solvent, and then the electrode conductive paste may be sintered at a temperature of 500° C. to 900° C. to form the sintered electrode layer.

For example, when the base electrode layers 131a and 132a include a resin electrode layer, the body may be dipped into a conductive resin composition including metal powder particles, resin, a binder, and an organic solvent, and then cured by heat treatment at a temperature of 250° C. to 550° C. to form the resin electrode layer.

In addition, the plating layers 131b and 132b may be formed on the base electrode layers 131a and 132a by further performing an electrolytic plating method and/or an electroless plating method.

### EXAMPLES

Sample chips were manufactured according to the above-described manufacturing method, and the sample chips were manufactured such that θL and R1/R2 of FIG. 4 satisfy Table 1 below. Moisture resistance reliability evaluation was conducted, and results thereof are indicated in Table 1 below.

In the moisture resistance reliability evaluation, 20,000 sample chips were prepared for each test number. A voltage of 3 Vr was applied for 12 hours at a temperature of 85° C. and a relative humidity of 85%. A sample chip was determined to be defective when an insulation resistance value of the sample chip decreased to 1/100 or less of an initial value, and the number of sample chips determined to be defective is indicated.

TABLE 1

| Test No. | θL(°) | R1/R2 | Moisture resistance reliability |
|---|---|---|---|
| 1 | 60 | 2.15 | 20 |
| 2 | 50 | 1.28 | 4 |
| 3 | 45 | 1.0 | 2 |
| 4 | 40 | 0.78 | 3 |
| 5 | 30 | 0.46 | 40 |

Referring to Table 1, in all of Test Nos. 1 to 5, the number of sample chips exhibiting moisture resistance reliability failure, among the 20,000 chips, was 40 or less, and it can be confirmed that the moisture resistance reliability failure rate was low at 0.2% or less. Such a result may be interpreted as a result of fundamentally suppressing the occurrence of chipping defects during a polishing process by reducing polishing time, as described above.

In particular, when θL is greater than 30 degrees and less than 60 degrees, the number of sample chips exhibiting moisture resistance reliability failure, among the 20,000 sample chips, was 4 or less, and it can be confirmed that the moisture resistance reliability failure rate was significantly low at 0.02% or less.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are for the purpose of describing particular example embodiments only and are to not be limiting of the example embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer and an internal electrode alternately disposed with the dielectric layer in a first direction, the body having first and second surfaces opposing each other in the first direction, third and fourth surfaces connected to the first and second surfaces, the third and fourth surfaces opposing each other in a second direction, fifth and sixth surfaces connected to the first to fourth surfaces, the fifth and sixth surfaces opposing each other in a third direction; and
an external electrode disposed on the third and fourth surfaces,
wherein, in at least one cross-section, among a cross-section in the first and second directions of the body and a cross-section in the first and third directions of the body, at least one of corner regions connecting two adjacent surfaces to each other, among the first to sixth surfaces, includes a first curved section connected to one surface, among the two adjacent surfaces, a second curved section connected to the other surface, among the two adjacent surfaces, and a straight section connecting the first and second curved sections to each other.

2. The multilayer electronic component of claim 1, wherein an acute angle, formed by the straight section and the first direction, is greater than 30 degrees and less than 60 degrees.

3. The multilayer electronic component of claim 1, wherein, when a radius of curvature of the first curved section is referred to as R1 and a radius of curvature of the second curved section is referred to as R2, R1/R2 is 0.78 or more and 1.28 or less.

4. The multilayer electronic component of claim 1, wherein
the body includes a capacitance formation portion including the internal electrode, a first cover portion disposed on an upper portion in the first direction of the capacitance formation portion, and a second cover portion disposed on a lower portion in the first direction of the capacitance formation portion, and
the at least one corner region is disposed in the first and second cover portions.

5. The multilayer electronic component of claim 4, wherein, when an average thickness in the first direction of the first cover portion is referred to as T1, and a length of a straight section of the at least one corner region disposed in the first cover portion is referred to as L1, 0.207≤L1/T1 is satisfied.

6. The multilayer electronic component of claim 5, wherein L1 and T1 satisfy 0.207≤L1/T1≤1.248.

7. The multilayer electronic component of claim 4, wherein, when an average thickness in the first direction of the first cover portion is referred to as T1, and radii of curvature of first and second curved sections of the at least one corner region disposed in the first cover portion are referred to as R1 and R2, respectively, R1/T1 and R2/T1 are 0.2 or more.

8. The multilayer electronic component of claim 7, wherein R1/T1 and R2/T1 are greater than or equal to 0.2 and less than 0.6.

9. The multilayer electronic component of claim 4, wherein, when an average thickness in the first direction of the first cover portion is referred to as T1, and a thickness in the first direction of the at least one corner region disposed in the first cover portion is referred to as Cz, TCz/T1≤0.75 is satisfied.

10. The multilayer electronic component of claim 1, wherein, in the cross-section in the first and third directions, the corner region includes a first-fifth corner region connecting the first and fifth surfaces to each other, a first-sixth corner region connecting the first and sixth surfaces to each other, a second-fifth corner region connecting the second and fifth surfaces to each other, and a second-sixth corner region connecting the second and sixth surfaces to each other.

11. The multilayer electronic component of claim 1, wherein, in the cross-section in the first and second directions, the corner region includes a first-third corner region connecting the first and third surfaces to each other, a first-fourth corner region connecting the first and fourth surfaces to each other, a second-third corner region connecting the second and third surfaces to each other, and a second-fourth corner region connecting the second and fourth surfaces to each other.

12. The multilayer electronic component of claim 1, wherein a maximum length in the second direction of the multilayer electronic component is 1.1 mm or more, and a maximum width in the third direction of the multilayer electronic component is 0.55 mm or more.

13. A method of manufacturing a multilayer electronic component, the method comprising:
forming a laminated bar by laminating a plurality of ceramic green sheets stacked in a first direction;
forming a first groove in a second direction, perpendicular to the first direction, and a second groove in a third direction, perpendicular to the first and second directions, in an upper surface and a lower surface in the first direction of the laminated bar;
obtaining a unit laminated bar by cutting the laminated bar along the grooves;
polishing the unit laminated bar to obtain a polished unit laminated bar;
obtaining a body by sintering the polished unit laminated bar; and
forming an external electrode on the body.

14. The method of claim 13, wherein
the plurality of ceramic green sheets include a first ceramic green sheet on which a first internal electrode pattern is printed, a second ceramic green sheet on which a second internal electrode pattern is printed, and a third ceramic green sheet on which the first and the second internal electrode patterns are not printed, and
the third ceramic green sheet is laminated in an upper portion and a lower portion in the first direction of the laminated bar, and the first and second ceramic green sheets are alternately laminated in a central portion in the first direction of the laminated bar.

15. The method of claim 14, wherein a thickness in the first direction of the first and second grooves formed in the upper surface in the first direction of the laminated bar is 50% or less of a thickness in the first direction of the upper portion in the first direction.

16. The method of claim 14, wherein the grooves are disposed in a region not overlapping at least one of the first internal electrode pattern and the second internal electrode pattern in the first direction.

17. The method of claim 13, wherein the first groove and the second groove have a V-shape respectively in a cross-section of the body in the first and third directions, and a cross-section of the body in the first and second directions.

18. The method of claim 17, wherein an angle, formed by two sides of the V-shape, is 80 degrees to 100 degrees.

19. The method of claim 17, wherein the cutting is performed along a point at which two sides of the V-shape meet.

20. A multilayer electronic component comprising:
a hexahedral body including a capacitance forming portion, the body having at least one edge, connecting two adjacent surfaces, which includes a first curved section connected to a first among the two adjacent surfaces, a second curved section connected to a second among the two adjacent surfaces, and a straight section disposed between and connecting the first and second curved sections,
wherein a ratio of a radius of curvature of the first curved section to a radius of curvature of the second curved section is in a range from 0.78 to 1.28.

21. The multilayer electronic component of claim 20, further comprising a first cover portion disposed above the capacitance forming portion in a thickness direction, and a second cover portion disposed below the capacitance forming portion in the thickness direction,
wherein the at least one edge is disposed in one or both of the first and second cover portions.

22. The multilayer electronic component of claim 21, wherein the at least one edge is disposed in the first cover portion, and wherein a ratio of average thickness T1 of the first cover portion in the first direction to a length L1 of the straight section in a direction connecting the first and second curved sections is in a range from 0.207 to 1.248.

23. The multilayer electronic component of claim 21, wherein the at least one edge is disposed in the first cover portion, and wherein when an average thickness of the first cover portion is T1, the radius of curvature of the first curved section is R1, and the radius of curvature of the second curved section is R2, both R1/T1 and R2/T1 are in a range from 0.2 to 0.6.
